(19) United States
(12) Patent Application Publication
(10) Pub. No.: US 2024/0384760 A1
(43) Pub. Date: Nov. 21, 2024

(54) Wheel Suspension for a Vehicle

(71) Applicant: Bayerische Motoren Werke Aktiengesellschaft, Muenchen (DE)

(72) Inventors: Bjoern BENEKE, Werdau (DE); Christopher ESCHENBACH, Olching (DE); Susanne GOLLWITZER-DRAEGER, Muenchen (DE); Stefan HAEUSLER, Muenchen (DE); Thomas HORNIG, Pfaffenhofen (DE); Philipp NASKO, Muenchen (DE); Felix CHLUESSLER, Lichtenstein (DE)

(21) Appl. No.: 18/691,948

(22) PCT Filed: Sep. 15, 2022
(86) PCT No.: PCT/EP2022/075599

§ 371 Date: Mar. 14, 2024

(30) Foreign Application Priority Data
Sep. 20, 2021 (DE) 10 2021 124 231.2

(51) Int. Cl. F16C 33/78; B60B 27/00; F16C 19/18

(52) U.S. Cl. CPC F16C 33/7816; B60B 27/0073; B60B 27/0094; F16C 19/183; F16C 2326/02

(57) ABSTRACT

A wheel suspension for a vehicle includes a wheel carrier with a flange and a wheel bearing which is fastened to the wheel carrier and has a wheel bearing outer race. The flange of the wheel carrier lies flat against the wheel bearing outer race of the wheel bearing. The wheel bearing is clamped against the wheel carrier by way of a plurality of screws distributed over the circumference of the wheel bearing outer race. A surface of the wheel bearing outer race that faces the flange has at least one step, as viewed in the direction of the rotation axis of the wheel bearing, which step is designed such that, in the screwed state of the wheel bearing outer race to the wheel carrier flange, a gap is formed in the region of the step between the wheel bearing outer race and the wheel carrier flange.

### BACKGROUND AND SUMMARY

The invention relates to a wheel suspension for a vehicle having a wheel carrier with a flange, a wheel bearing fastened to the wheel carrier and having a wheel bearing outer ring, wherein the flange of the wheel carrier lies flat on the wheel bearing outer ring of the wheel bearing.

For prior art, reference is made, by way of example, to DE 10 2015 220 774 A1.

Wheel carriers (also referred to as pivot bearings), which are also referred to as steering knuckles, are known to a person skilled in the art in a wide variety of embodiments. On the pivot bearing there is fastened or flanged a wheel bearing on which, in turn, a wheel of the vehicle (rotatable with respect to the pivot bearing about the rotation axis of the wheel bearing) is flanged or fastened. A common way of fastening the wheel bearing on the pivot bearing is a screw connection by means of a plurality of screws which are distributed over the circumference of the wheel bearing and whose longitudinal axes run parallel to the rotational axis of the wheel bearing.

Passenger cars are increasingly also designed to have a high degree of comfort, with it being sought to keep the introduction of disturbing noises into the vehicle interior as low as possible. Since ambient noise is virtually completely blocked out, vehicle occupants are becoming increasingly aware of small disturbing noises whose transmission path cannot be easily damped. For example, slight clicking noises enter the vehicle interior at times or depending on the driving state. These noises have been identified as emanating from the pivot bearing. In the current state of the art, what happens when screwing the wheel bearing to the wheel carrier with full-surface contact area is that undesired deformations of the entire wheel bearing/wheel carrier assembly occur. This results in raceway deformations of the ball set in the wheel bearing with an influence on the wheel bearing friction and in a higher sensitivity to micro-movements in the contact region between the wheel bearing and the wheel carrier. The micro-movements lead, inter alia, to the aforementioned undesired acoustic defects.

A remedial measure against this is shown in DE 10 2015 220 774 A1. There is provision here that, as viewed in the rotation axis direction of the wheel bearing, the flange surface of the pivot bearing that faces the wheel bearing collar and/or the collar surface of the wheel bearing that faces the flange are or is configured to be not completely planar such that, when the wheel bearing collar is not clamped against the flange, said collar, as viewed over its circumference, does not lie with full-surface contact on the provided flange surface and, in the clamped state, the contact surface between the wheel bearing collar and the flange is greater than in the nonclamped state. This non-completely planar collar surface is intended to be achieved by means of a curvature in the bearing surface of the pivot bearing in the region of the flange connection to the wheel bearing. This curvature then allows an elastic deformation of the pivot bearing that occurs when screwing or clamping the wheel bearing collar to the pivot bearing. A sufficiently high surface pressure is thus achieved in the region between two adjacent screws.

However, this embodiment has the disadvantage that the desired effect occurs only by clamping the wheel bearing to the wheel carrier. Clamping the two surfaces also causes the raceways of the ball set that are situated in the collar to be deformed. This deformation is in turn accompanied by the aforementioned negative influence on the wheel bearing friction.

An elastic deformation by a curvature in the flange surface of the wheel carrier that faces the wheel bearing collar can moreover only be chosen to be comparatively small for strength reasons. The implementation and effectiveness of such a curvature is limited on account of negative effects on the wheel bearing friction and the strength.

It is thus an object of the invention to provide a wheel suspension for a motor vehicle that is improved in terms of the aforementioned disadvantages.

The object is achieved by a wheel suspension for a vehicle and by a vehicle having the features of the independent claims. Advantageous embodiments and developments form the content of the dependent claims.

A wheel suspension for a vehicle is proposed which comprises a wheel carrier or a pivot bearing with a flange for attaching a wheel bearing. Furthermore, the wheel suspension comprises such a wheel bearing, with the latter comprising a wheel bearing outer ring (race). Preferably, at least one raceway of a ball set is arranged in the wheel bearing outer ring.

The wheel bearing is furthermore connected to the flange of the wheel carrier via the wheel bearing outer ring. The flange of the wheel carrier and the wheel bearing outer ring lie flat on one another. Preferably, the wheel bearing outer ring is designed in such a way that it is arranged on the flange so as to support radial forces. For this purpose, the wheel bearing outer ring can comprise, for example, a type of collar which engages in the flange and thus produces a form-fitting connection between the flange and the wheel bearing outer ring.

The wheel bearing outer ring is, as already stated, preferably arranged to lie flat on the flange in such a way that it can support radial forces.

The wheel bearing is furthermore clamped against the wheel carrier by means of a plurality of screws distributed over the circumference of the wheel bearing outer ring. The screw connection in particular also serves for the axial support (that is to say in the rotation axis direction) of forces (that is to say of so-called axial forces).

Particularly preferably, at least three, particularly preferably four, screws are provided which are distributed on the wheel bearing outer ring circumference.

The regions or the flange-facing surface portions of the wheel bearing outer ring on which the screws are arranged or which are penetrated by the screws preferably form so-called screwing surfaces. Those remaining surface portions of the wheel bearing outer ring which no longer belong to a screwing surface and which interconnect the respective screwing surfaces are preferably referred to as web surfaces.

There is provision that, as viewed in the rotation axis direction of the wheel bearing, a surface of the wheel bearing outer ring that faces the flange comprises at least one step. Such a step can be formed, for example, in the form of a clearance, a groove or a blind hole-like cutout. There is preferably provision here that the surface of the wheel bearing outer ring that is offset in the rotation axis direction by the step is designed to be at least predominantly flat or planar.

The step is designed in such a way that, as viewed over its circumference, the wheel bearing outer ring, in the screwed or connected state to the wheel carrier, does not lie with full-surface contact on the provided flange surface. Instead, in the screwed or clamped state, this step forms a gap between the contact surface of the wheel bearing outer ring and the wheel carrier flange.

It is essential here that the gap formed by the step is designed independently of the clamping state of the components to be screwed. In the region of the step, that is to say at the location where the step is provided, the wheel bearing outer ring and the wheel carrier flange, in particular in the screwed state, are not in contact with one another. A surface pressure or any contact at all between the screwed components in the region of the step or the gap is therefore not present.

Particularly preferably, the step is about 2 mm to 5 mm high such that the surface of the wheel bearing outer ring on which the step is arranged is offset by about 2 mm to 5 mm in the rotation axis direction in the direction of the vehicle exterior. Particularly preferably, the height of the step is about 3 mm. Such a step height accordingly allows a correspondingly large (about 2-5 mm) gap between the wheel bearing outer ring and the wheel carrier flange that ensures sufficient drying in the case of moisture ingress and thus avoids possible corrosion formation. If required, an additional water drain can be provided in the pivot bearing geometry or wheel carrier geometry. A seal (and its complicated or additional manufacturing step) can thus be advantageously spared. A gap of this order of magnitude is possible only with difficulty or unfavorable through a step formation by means of a corresponding wheel carrier geometry on account of strength problems.

Alternatively or additionally, it is also possible to provide such a seal in the gap, that is to say between the wheel bearing outer ring and the wheel carrier flange, which seals the two components fluidically from one another. In the case of a seal, the step can also be designed to be smaller and be, for example, only 0.5 mm high. Such a seal can, for example, be vulcanized onto the wheel bearing outer ring or onto the wheel carrier flange.

In a preferred embodiment of the invention, the wheel bearing outer ring is produced in a forging method and accordingly thus designed as a forged component. In particular, the wheel bearing outer ring is designed as a steel or aluminum forged component. There is particularly preferably provision here that at least one step is produced directly in the forging method (that is to say for example by integration in the forging tool) of the wheel bearing outer ring. A subsequent machining operation for producing a step can therefore be advantageously spared

There is also preferably provision that the wheel carrier is produced in a forging or casting method. The wheel carrier can, for example, be produced from an aluminum or steel material. Particularly by comparison with a sheet metal component, a forged or cast component has manufacturing-related advantages (since sheet metal constructions have to be welded, for example) and is also advantageous in terms of stiffness.

In a further preferred embodiment of the invention, the at least one step is arranged on a web surface of the wheel bearing outer ring. For example, at least one step can be arranged on each web surface. It is also possible that the step is arranged only in certain web surfaces.

Particularly preferably, a step extends along at least approximately the entire circumference of a web surface (as viewed in the circumferential direction of the wheel bearing outer ring).

As already stated above, preferably at least three, preferably exactly four, screws and thus also as many screwing surfaces corresponding to the number of screws are provided on the wheel bearing outer ring. There is also provision here that in each case a screwing surface is spaced differently far apart from its adjoining screwing surfaces. That is to say, conversely, that, as viewed in the circumferential direction, the wheel bearing outer ring has longer and shorter web surfaces. In a preferred embodiment of the invention, in each case at least one step is situated in the longer web surfaces—that is to say on those web surfaces which interconnect the screwing surfaces having the greater distance from one another. This step preferably extends in each case over at least approximately the entire length (as viewed in the circumferential direction) of the web surface, resulting in a gap which is as long as possible (as viewed in the circumferential direction of the wheel bearing outer ring) between the wheel bearing outer ring and the wheel carrier flange.

These and further features can be gathered not only from the claims and from the description but also from the drawings, it being possible for the individual features, in each case individually or jointly in the form of subcombinations, to be implemented in an embodiment of the invention, and to represent advantageous, independently protectable embodiments for which protection is claimed here.

By virtue of such a step or by virtue of a gap, which is produced by the step, on the bearing surface in the wheel bearing outer ring, in particular in the region of the web surfaces, on the one hand the deformation of the assembly in the region of the screw-on points or in the region of the screwing surfaces is decoupled as far as possible from the deformations in the region of the wheel bearing raceways. It is thus possible to significantly reduce the negative influence on the wheel bearing friction caused by the clamping or screwing of the wheel bearing outer ring to the wheel carrier. That is to say that the overall friction of the wheel bearing in the mounted state is reduced. On the other hand, the sensitivity to micro-movements in the gap is reduced, since the critical regions no longer have any contact and the relative movements are reduced.

Also proposed is a vehicle which comprises such a wheel suspension.

The invention makes it possible to avoid a surface pressure in the regions in which a step is provided, which in turn prevents disadvantageous micro-movements in the otherwise present contact surface between the wheel bearing outer ring and the pivot bearing. Undesired acoustic defects generated by such micro-movements can therefore be advantageously avoided. It is possible at the same time to ensure a low-outlay manufacturing process for producing the wheel suspension, with furthermore a wheel carrier construction which is as stiff as possible being ensured.

The invention will be explained in more detail below with reference to an exemplary embodiment. All of the features described in further detail may be essential to the invention.

### BRIEF DESCRIPTION OF THE DRAWINGS

FIG. 1 shows an exemplary wheel bearing of a wheel suspension in a three-dimensional front view.

FIG. 2 shows a three-dimensional front view of a wheel carrier with a wheel bearing connected thereto.

FIG. 3 shows a sectional view through the wheel carrier/wheel bearing assembly from FIG. 2.

### DETAILED DESCRIPTION OF THE DRAWINGS

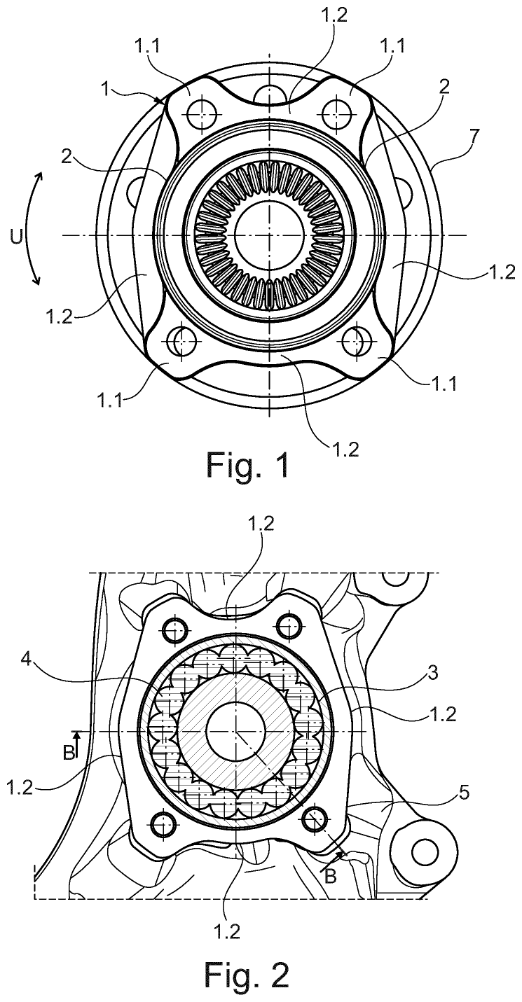

In FIG. 1 there can be seen a wheel bearing of a wheel suspension of a vehicle, which comprises a wheel bearing outer ring 1. In the installed state of the wheel bearing, the wheel bearing outer ring 1 is in contact with a wheel carrier flange (not shown). In addition to the wheel bearing outer ring 1, the wheel bearing from FIG. 1 comprises a wheel bearing flange hub 7 for fastening to a vehicle wheel (not shown).

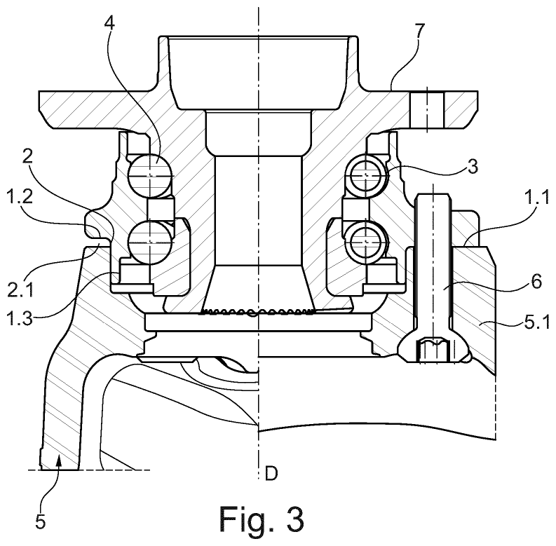

As can be seen in FIG. 1, the surface of the wheel bearing outer ring 1 that faces a wheel carrier (not shown) is divided by two steps 2 over two planes which are offset with respect to one another in the rotation axis direction D (cf. FIG. 3). The wheel bearing outer ring 1 comprises four screwing surfaces 1.1 through which in each case a screw (not shown) for attaching to the wheel carrier flange (not shown) can be arranged. The screwing surfaces 1.1 are connected to one another by web surfaces 1.2 in the circumferential direction U of the wheel bearing outer ring 1.

In each case a step 2 is provided on those web surfaces 1.2 which connect the screwing surfaces 1.1 having the greater distance from one another.

FIG. 2 shows a view of a wheel bearing/wheel carrier assembly, wherein the wheel bearing from FIG. 1 is arranged so as to be mounted on a wheel carrier 5. The surface of the wheel bearing outer ring 1 that is provided with the step 2 and faces the wheel carrier 5 cannot be seen in FIG. 2. For the sake of clarity, the wheel bearing flange hub 7 depicted in FIG. 1 is also not shown in FIG. 2. Within the wheel bearing outer ring 1 there runs (shown by a partial section) a raceway 3 of a ball set 4.

As can be seen in FIG. 3, in the sectional view B-B of the wheel bearing/wheel carrier assembly from FIG. 2, the wheel carrier 5 comprises a wheel carrier flange 5.1 which is clamped to the wheel bearing outer ring 1 by four screws 6. The surface of the wheel bearing outer ring 1 that faces the flange 5.1 lies on the flange surface 5.1. Furthermore, the wheel bearing outer ring 1 is connected to the flange 5.1 in a form-fitting manner, with the result that radial forces can be absorbed. This form fit is produced by means of a collar 1.3 which is arranged on the wheel bearing outer ring and engages in the flange 5.1.

It can be seen in particular in FIG. 3 that a gap 2.1 is formed in the region of the step 2 which is arranged on the wheel bearing outer ring 1 on a web surface 1.2. On the screwing surface 1.1, by contrast, no step 2 and thus also no gap 2.1 are provided—an optimum surface pressure in the region of the screwing surface can thus be ensured. In the region of the gap 2.1, the flange surface 5.1 is not in contact with the surface of the wheel bearing outer ring 1 that faces the flange 5.1.

By virtue of this gap 2.1, contact between the wheel bearing outer ring 1 and the flange 5.1 in the region of the steps 2 on the web surfaces 1.2 is advantageously avoided. Therefore, a surface pressure in this region can also be avoided, which in turn prevents disadvantageous (in particular acoustically disadvantageous) micro-movements in the otherwise present separating joint and wheel bearing friction-relevant raceway deformations when clamping.

1.-9. (canceled)

10. A wheel suspension for a vehicle, comprising:
a wheel carrier with a flange;
a wheel bearing fastened to the wheel carrier and having a wheel bearing outer ring;
wherein the flange of the wheel carrier lies flat on the wheel bearing outer ring of the wheel bearing;
wherein the wheel bearing is clamped against the wheel carrier via a plurality of screws distributed over a circumference of the wheel bearing outer ring, and
wherein, as viewed in a rotational axis direction of the wheel bearing, a surface of the wheel bearing outer ring that faces the flange comprises at least one step, which step is configured such that, in a screwed state of the wheel bearing outer ring to the wheel carrier flange, a gap between the wheel bearing outer ring and the wheel carrier flange is formed in a region of the step.

11. The wheel suspension according to claim 10, wherein
the wheel bearing outer ring surface that faces the flange comprises screwing surfaces for arranging a respective screw and also web surfaces connecting the screwing surfaces, and
the at least one step is arranged in at least one web surface.

12. The wheel suspension according to claim 11, wherein
at least three screwing surfaces are provided, and
in each case, a screwing surface is spaced differently far apart from an adjoining one of the screwing surfaces, and
in each case, at least one step is arranged on that web surface which connects the screwing surfaces having the greater distance from one another.

13. The wheel suspension according to claim 11, wherein
the step extends over at least approximately an entire circumference of the web surface.

14. The wheel suspension according to claim 11, wherein
as viewed in the rotational axis direction and in a direction of the vehicle interior, the step is approximately 2 mm-5 mm high.

15. The wheel suspension according to claim 10, further comprising:
a seal for fluidically sealing the wheel bearing outer ring from the wheel carrier flange, the seal being arranged in the gap.

16. The wheel suspension according to claim 10, wherein
the wheel bearing outer ring is a forged component, and
the at least one step is produced during forging of the wheel bearing outer ring.

17. The wheel suspension according to claim 10, wherein
the wheel carrier is a forged or cast wheel carrier.

18. A vehicle comprising at least one wheel suspension according to claim 10.
